(19) United States
(12) Patent Application Publication
(10) Pub. No.: US 2024/0365287 A1
(43) Pub. Date: Oct. 31, 2024

(54) METHOD FOR WIRELESS COMMUNICATION AND TERMINAL DEVICE

(71) Applicant: GUANGDONG OPPO MOBILE TELECOMMUNICATIONS CORP., LTD., Dongguan (CN)

(72) Inventors: Shichang ZHANG, Dongguan (CN); Zhenshan ZHAO, Dongguan (CN); Huei-Ming LIN, Taipei (CN)

(21) Appl. No.: 18/767,517

(22) Filed: Jul. 9, 2024

Related U.S. Application Data
(63) Continuation of application No. PCT/CN2022/071353, filed on Jan. 11, 2022.

(51) Int. Cl. H04W 72/02; H04W 72/25; H04W 72/40

(52) U.S. Cl. CPC H04W 72/02; H04W 72/25; H04W 72/40

(57) ABSTRACT

A method for wireless communication and a terminal device are provided. A first terminal device can determine type information of resources in a target resource set to be provided to a second terminal device, so that the second terminal device can perform resource selection based on the target resource set, thereby improving reliability of transmission. The method for wireless communication includes the following. A first terminal device determines type information of resources in a target resource set to be provided to a second terminal device. The target resource set is used by the second terminal device to perform resource selection. The target resource set contains at least one of: a type of resources suitable for use by the second terminal device or a type of resources unsuitable for use by the second terminal device.

### CROSS-REFERENCE TO RELATED APPLICATION(S)

This application is a continuation of International Application No. PCT/CN2022/071353, filed Jan. 11, 2022, the entire disclosure of which is hereby incorporated by reference.

### TECHNICAL FIELD

This disclosure relates to the field of communication, and more specifically to a method for wireless communication and a terminal device.

### BACKGROUND

In sidelink (SL) communication, when a terminal device (e.g., UE-A) receives an explicit request from another terminal device (e.g., UE-B) or satisfies a specific condition, UE-A can acquire a resource set according to a resource sensing result, an indication of a network device, and the like, and transmit the resource set to UE-B. However, how UE-A determines which type of resources needs to be contained in a resource set to be provided to UE-B is an urgent problem to be solved.

### SUMMARY

A method for wireless communication and a terminal device are provided in embodiments of the disclosure.

In a first aspect, a method for wireless communication is provided. The method includes the following. A first terminal device determines type information of resources in a target resource set to be provided to a second terminal device. The target resource set is used by the second terminal device to perform resource selection. The target resource set contains at least one of: a type of resources suitable for use by the second terminal device or a type of resources unsuitable for use by the second terminal device.

In a second aspect, a terminal device is provided. The terminal device includes a transceiver, a processor coupled to the transceiver, and a memory storing a computer program which, when executed by the processor, causes the terminal device to determine type information of resources in a target resource set to be provided to another terminal device. The target resource set is used by the other terminal device to perform resource selection. The target resource set contains at least one of: a type of resources suitable for use by the other terminal device or a type of resources unsuitable for use by the other terminal device.

In a third aspect, a terminal device is provided. The terminal device includes a transceiver, a processor coupled to the transceiver, and a memory storing a computer program which, when executed by the processor, causes the terminal device to receive first information from another terminal device. The first information contains a target resource set, and the target resource set is used by the terminal device to perform resource selection. The target resource set contains at least one of: a type of resources suitable for use by the terminal device or a type of resources unsuitable for use by the terminal device.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiment described herein.

### BRIEF DESCRIPTION OF THE DRAWINGS

FIG. 1 is a schematic architectural diagram of a communication system provided in the disclosure.

FIG. 2 is a schematic architectural diagram of another communication system provided in the disclosure.

FIG. 3 is a schematic diagram illustrating in-coverage sidelink (SL) communication provided in the disclosure.

FIG. 4 is a schematic diagram illustrating partial-coverage SL communication provided in the disclosure.

FIG. 5 is a schematic diagram illustrating out-of-coverage SL communication provided in the disclosure.

FIG. 6 is a schematic diagram illustrating SL communication with a central control node provided in the disclosure.

FIG. 7 is a schematic diagram illustrating unicast SL communication provided in the disclosure.

FIG. 8 is a schematic diagram illustrating multicast SL communication provided in the disclosure.

FIG. 9 is a schematic diagram illustrating broadcast SL communication provided in the disclosure.

FIG. 10 is a schematic diagram illustrating frame structures of a physical sidelink control channel (PSCCH) and a physical sidelink shared channel (PSSCH) provided in the disclosure.

FIG. 11 is a schematic diagram illustrating a hidden node provided in the disclosure.

FIG. 12 is a schematic diagram illustrating an exposed terminal provided in the disclosure.

FIG. 13 is a schematic flow chart of a method for wireless communication provided in embodiments of the disclosure.

FIG. 14 is a schematic diagram of a first media access control control element (MAC CE) provided in embodiments of the disclosure.

FIG. 15 is a schematic diagram of a second MAC CE provided in embodiments of the disclosure.

FIG. 16 is a schematic flow chart of another method for wireless communication provided in embodiments of the disclosure.

FIG. 17 is a schematic block diagram of a terminal device provided in embodiments of the disclosure.

FIG. 18 is a schematic block diagram of another terminal device provided in embodiments of the disclosure.

FIG. 19 is a schematic block diagram of a communication device provided in embodiments of the disclosure.

FIG. 20 is a schematic block diagram of an apparatus provided in embodiments of the disclosure.

FIG. 21 is a schematic block diagram of a communication system provided in embodiments of the disclosure.

### DETAILED DESCRIPTION

The following will describe technical solutions of embodiments of the disclosure with reference to the accompanying drawings in embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

The technical solutions of embodiments of the disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), an internet of things (IoT), a wireless fidelity (WiFi), a 5th-generation (5G) communication system, or other communication systems.

Generally speaking, a conventional communication system supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, or vehicle to everything (V2X) communication, or the like. Embodiments of the disclosure may also be applied to these communication systems.

Optionally, the communication system in embodiments of the disclosure may be applied to a carrier aggregation (CA) scenario, a dual connectivity (DC) scenario, or a standalone (SA) network deployment scenario.

Optionally, the communication system in embodiments of the disclosure is applicable to an unlicensed spectrum, and an unlicensed spectrum may be regarded as a shared spectrum. Alternatively, the communication system in embodiments of the disclosure is applicable to a licensed spectrum, and a licensed spectrum may be regarded as a non-shared spectrum.

Various embodiments of the disclosure are described in connection with a network device and a terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, or a user device, etc.

The terminal device may be a station (ST) in a WLAN, a cellular radio telephone, a cordless telephone, a session initiation protocol (SIP) telephone, a wireless local loop (WLL) station, a personal digital assistant (PDA), a handheld device or a computing device with wireless communication functions, other processing devices coupled with a wireless modem, an in-vehicle device, a wearable device, and a terminal device in a next-generation communication system, for example, a terminal device in an NR network, or a terminal device in a future evolved public land mobile network (PLMN), etc.

In embodiments of the disclosure, the terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

In embodiments of the disclosure, the terminal device may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city or a wireless terminal device in smart home, an in-vehicle communication device, a wireless communication chip/application specific integrated circuit (ASIC)/system on chip (SoC), or the like.

By way of explanation rather than limitation, in embodiments of the disclosure, the terminal device may also be a wearable device. The wearable device may also be referred to as a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the disclosure, the network device may be a device configured to communicate with a mobile device, and the network device may be an access point (AP) in a WLAN, a base transceiver station (BTS) in GSM or CDMA, may also be a Node B (NB) in WCDMA, or may be an evolutional Node B (eNB or eNodeB) in LTE, or a relay station or AP, or an in-vehicle device, a wearable device, a network device or base station (gNB) in an NR network, a network device in a future evolved PLMN, or a network device in an NTN, etc.

By way of explanation rather than limitation, in embodiments of the disclosure, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In embodiments of the disclosure, the network device serves a cell, and the terminal device communicates with the network device over a transmission resource (for example, a frequency-domain resource or a spectrum resource) for the cell. The cell may be a cell corresponding to the network device (for example, a base station). The cell may belong to a macro base station, or may belong to a base station corresponding to a small cell. The small cell may include: a metro cell, a micro cell, a pico cell, a femto cell, and the like. These small cells are characterized by small coverage and low transmission power and are adapted to provide data transmission service with high-rate.

It may be understood that, the terms “system” and “network” herein are usually used interchangeably throughout this disclosure. The term “and/or” herein only describes an association relationship between associated objects, which means that there can be three relationships. For example, A and/or B can mean A alone, both A and B exist, and B alone. In addition, the character “/” herein generally indicates that the associated objects are in an “or” relationship.

Terms used in the implementation part of the disclosure are only intended for explaining embodiments of the disclosure rather than limiting the disclosure. The terms “first”, “second”, “third”, and “fourth”, etc. in the specification and claims of the disclosure and in the accompanying drawings are intended for distinguishing different objects rather than describing a particular order. In addition, the terms “include”, “comprise”, and “have” as well as variations thereof are intended to cover non-exclusive inclusion.

It may be understood that, “indication” referred to in embodiments of the disclosure may be a direct indication, may be an indirect indication, or may mean that there is an association relationship. For example, A indicates B may mean that A directly indicates B, for instance, B can be obtained according to A; may mean that A indirectly indicates B, for instance, A indicates C, and B can be obtained according to C; or may mean that there is an association relationship between A and B.

In the elaboration of embodiments of the disclosure, the term “correspondence” may mean that there is a direct or indirect correspondence between the two, may mean that there is an association between the two, or may mean a relationship of indicating and being indicated or configuring and being configured, etc.

In embodiments of the disclosure, the “pre-defined” or “pre-configured” can be implemented by pre-saving a corresponding code or table in a device (for example, including the terminal device and the network device) or in other manners that can be used for indicating related information, and the disclosure is not limited in this regard. For example, the “pre-defined” may mean defined in a protocol.

In embodiments of the disclosure, the “protocol” may refer to a communication standard protocol, which may include, for example, an LTE protocol, an NR protocol, and a protocol applied to a future communication system, and the disclosure is not limited in this regard.

For better understanding of technical solutions of embodiments of the disclosure, the technical solutions of embodiments of the disclosure will be described in detail below in connection with embodiments. The related art below, as an optional scheme, can be arbitrarily combined with the technical solutions of embodiments of the disclosure, which shall all belong to the protection scope of the disclosure. Embodiments of the disclosure include at least part of the following.

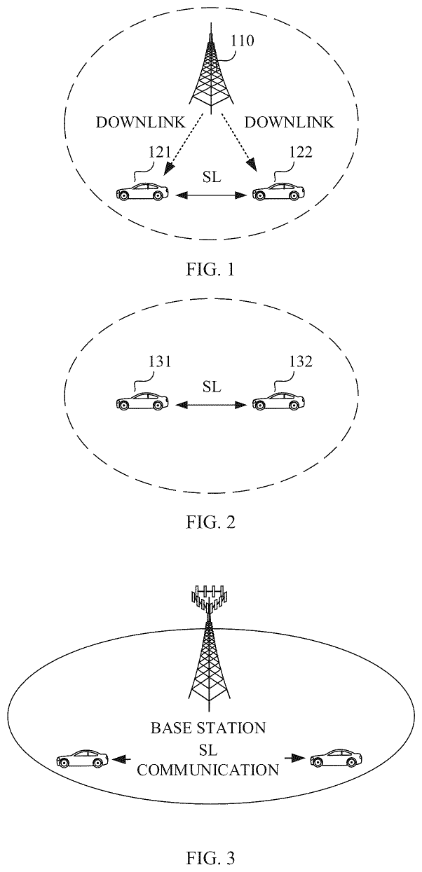

FIG. 1 is a schematic diagram of a communication system to which embodiments of the disclosure are applicable. A transmission resource(s) for an in-vehicle terminal (in-vehicle terminal 121 and in-vehicle terminal 122) is allocated by a base station 110, and the in-vehicle terminal performs data transmission on a sidelink (SL) over the resource(s) allocated by the base station 110. Specifically, the base station 110 may allocate to the terminal a resource(s) for single transmission, or may also allocate to the terminal a resource(s) for semi-persistent transmission.

FIG. 2 is a schematic diagram of another communication system to which embodiments of the disclosure are applicable. An in-vehicle terminal (in-vehicle terminal 131 and in-vehicle terminal 132) autonomously selects, from SL resources, a transmission resource(s) for data transmission. Optionally, the in-vehicle terminal may select a transmission resource(s) randomly, or may select a transmission resource(s) by sensing.

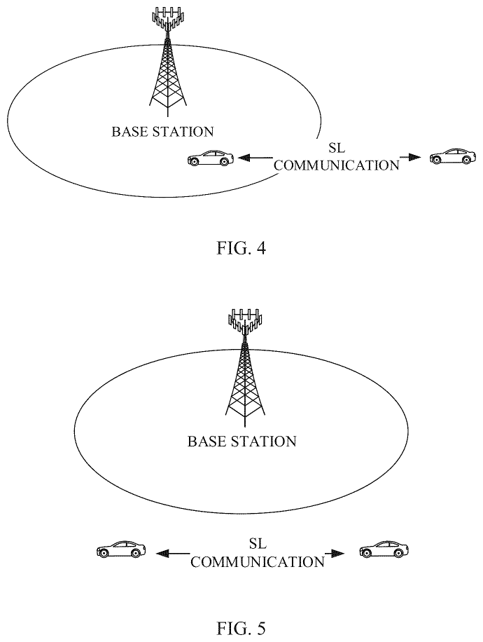

It may be noted that, according to a network coverage condition of terminals in communication, SL communication may be classified into in-coverage SL communication as illustrated in FIG. 3, partial-coverage SL communication as illustrated in FIG. 4, and out-of-coverage SL communication as illustrated in FIG. 5.

As illustrated in FIG. 3, in in-coverage SL communication, all terminals in SL communication are located within a coverage of a base station, so that all the terminals can receive configuration signaling from the base station and perform SL communication based on the same SL configuration.

As illustrated in FIG. 4, in partial-coverage SL communication, some of terminals in SL communication are located within a coverage of a base station, and these terminals can receive configuration signaling from the base station and perform SL communication based on a configuration from the base station. However, a terminal(s) located out of a coverage of a network cannot receive the configuration signaling from the base station. In this case, the terminal(s) out of the coverage of the network may determine an SL configuration according to pre-configuration information as well as information carried in a physical sidelink broadcast channel (PSBCH) transmitted by the terminal(s) located within the coverage of the network, and then perform SL communication.

As illustrated in FIG. 5, in out-of-coverage SL communication, all terminals in SL communication are located out of a coverage of a network, and all the terminals may determine an SL configuration according to pre-configuration information and then perform SL communication.

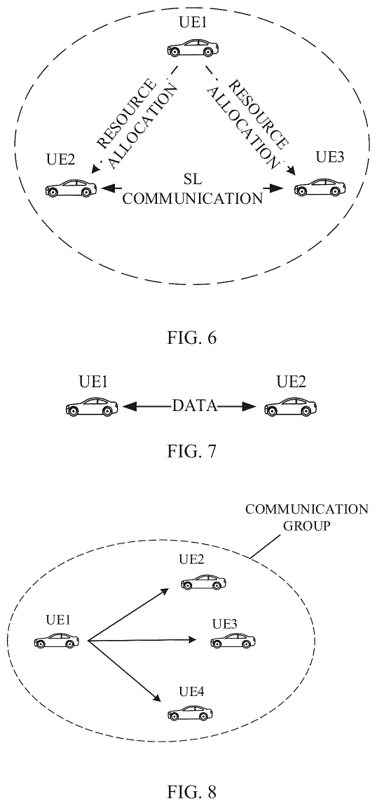

As illustrated in FIG. 6, in SL communication with a central control node, multiple terminals constitute a communication group, and the communication group includes a central control node, which may also be referred to as a cluster header (CH). The central control node has one of the following functions: being responsible for establishment of a communication group; adding a member(s) to the group and removing a member(s) from the group; performing resource coordination, such as allocating SL transmission resources to other terminals, and receiving SL feedback information from other terminals; communicating with other communication groups for resource coordination, or the like.

It may be noted that, D2D communication is a D2D-based SL transmission technology. Different from a traditional cellular system in which communication data is received or transmitted by a base station, a V2X system adopts D2D direct communication, thereby having higher spectral efficiency and lower transmission delay. In the 3rd generation partnership project (3GPP), two transmission modes are defined, which are referred to as mode 1 (i.e., sidelink resource allocation mode 1) and mode 2 (i.e., sidelink resource allocation mode 2) respectively.
Mode 1: a transmission resource(s) for a terminal is allocated by a base station, and the terminal performs data transmission on an SL on the resource(s) allocated by the base station. The base station may allocate to the terminal a resource(s) for single transmission, or may allocate to the terminal a resource(s) for semi-persistent transmission. As illustrated in FIG. 3, the terminal is located within the coverage of the network, and the network allocates to the terminal a transmission resource(s) for SL transmission.
Mode 2: the terminal selects a resource(s) for data transmission from a resource pool. As illustrated in FIG. 5, the terminal is located out of a coverage of a cell, and the terminal autonomously selects a transmission resource(s) for SL transmission from a pre-configured resource pool. Alternatively, as illustrated in FIG. 3, the terminal autonomously selects a transmission resource(s) for SL transmission from a resource pool configured by the network.

In some embodiments, resource selection in mode 2 may be performed in the following two operations.

Step 1, the terminal takes all available resources in a resource selection window as resource set A.

In a case where the terminal performs data transmission in some slots in a sensing window without sensing, the terminal may exclude all resources in slots in the selection window which correspond to these slots in the sensing window. The terminal determines corresponding slots in the selection window based on a value set of a “resource reservation period” field in a resource pool configuration.

In a case where a physical sidelink control channel (PSCCH) is sensed by the terminal in the sensing window, the terminal may measure reference signal received power (RSRP) of the PSCCH or an RSRP of a physical sidelink shared channel (PSSCH) scheduled by the PSCCH. In a case where the measured RSRP is greater than an SL-RSRP threshold, and the terminal determines, according to resource reservation information in sidelink control information (SCI) transmitted on the PSCCH, that a resource(s) reserved by the terminal is within the resource selection window, the terminal may exclude from resource set A the resource(s) reserved by the terminal. In a case where remaining resources in resource set A subject to resource exclusion is less than X % of all the resources in resource set A without subject to resource exclusion, the terminal may increase the SL-RSRP threshold by 3 decibels (dB) and repeat step 1. The possible values of X may be {20, 35, 50}, and the terminal determines parameter X from the value set according to a priority of data to be transmitted by the terminal. In addition, the above SL-RSRP threshold depends on a priority carried in the PSCCH sensed by the terminal and the priority of the data to be transmitted by the terminal. The terminal takes the remaining resources in resource set A subject to resource exclusion as a candidate resource set.

Step 2, the terminal selects some resources randomly from the candidate resource set, and takes these resources as transmission resources for initial transmission and retransmission.

In NR-V2X, automatic driving is supported. Therefore, NR-V2X has higher requirements on data interaction between vehicles, such as higher throughput, lower delay, higher reliability, larger coverage, more flexible resource allocation, and the like.

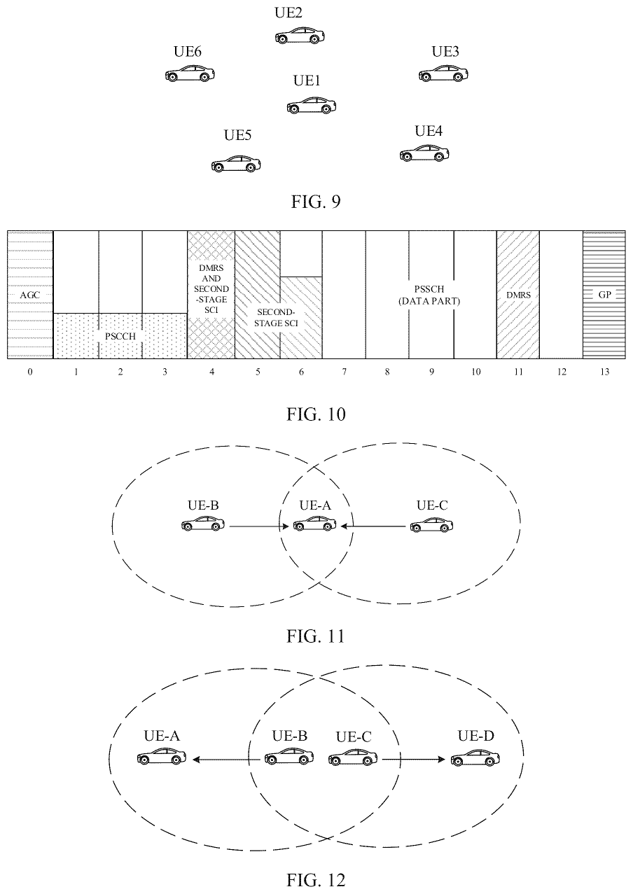

In LTE-V2X, a broadcast transmission mode is supported. In NR-V2X, a unicast transmission mode and a multicast transmission mode are introduced. In unicast transmission, only one terminal may serve as a receiving terminal. As illustrated in FIG. 7, unicast transmission is performed between UE 1 and UE 2. In multicast transmission, all terminals in a communication group or all terminals within a certain transmission distance may serve as receiving terminals. As illustrated in FIG. 8, UE 1, UE 2, UE 3, and UE 4 constitute a communication group, where UE 1 transmits data, and other terminal devices in the group all serve as receiving terminals. In the broadcast transmission mode, any one of terminals around a transmitting terminal may serve as a receiving terminal. As illustrated in FIG. 9, UE 1 serves as a transmitting terminal, and other terminals, i.e., UE 2 to UE 6, around UE 1 all serve as receiving terminals.

In an SL transmission system, a resource pool is introduced. The resource pool is a set of transmission resources. No matter whether a transmission resource is a transmission resource configured by the network or a transmission resource autonomously selected by the terminal, the transmission resource is a resource in the resource pool. The resource pool may be pre-configured or may be configured by the network, and one or more resource pools may be configured. The resource pool is classified into a transmission resource pool and a receiving resource pool. Transmission resources in the transmission resource pool are used for SL data transmission. Transmission resources in the receiving resource pool are used by the terminal to receive SL data.

For better understanding of embodiments of the disclosure, SCI involved in the disclosure will be described.

Two-stage SCI is introduced in NR-V2X. First-stage SCI is carried in the PSCCH and indicates information such as a transmission resource(s) for the PSSCH, information of reserved resources, an order of modulation and coding scheme (MCS), and priority information. Second-stage SCI is transmitted on the resource(s) for the PSSCH, is demodulated with a demodulation reference signal (DMRS) for the PSSCH, and indicates information for data demodulation, such as an identity (ID) of a transmitting end (also referred to as a source ID), an ID of a receiving end (also referred to as a destination ID), a hybrid automatic repeat reQuest (HARQ) ID, a new data indicator (NDI). The first symbol is often used for auto gain control (AGC). The PSCCH occupies symbols in a slot starting from the second symbol. The last symbol often serves as a guard period (GP). The second-stage SCI is first mapped to a symbol where a first DMRS symbol of the PSSCH is located in an order of first frequency domain and then time domain. As illustrated in FIG. 10, the PSCCH occupies three symbols (symbol 1, symbol 2, and symbol 3), the DMRS for the PSSCH occupies symbol 4 and symbol 11, the second-stage SCI is mapped starting from symbol 4, the second-stage SCI and the DMRS are multiplexed in frequency-division multiplexing in symbol 4, and the second-stage SCI is mapped to symbol 4, symbol 5, and symbol 6. A size of resources occupied by the second-stage SCI depends on the number (quantity) of bits of the second-stage SCI.

For better understanding of embodiments of the disclosure, enhanced resource allocation in NR-V2X involved in the disclosure will be described.

In mode 2 described above, a terminal device selects a transmission resource(s) randomly from a resource pool, or selects a transmission resource(s) according to a sensing result. In such a resource selection mode, interference between terminals can be avoided to some extent, but such the resource selection mode has the following problems.
1. Hidden node: as illustrated in FIG. 11, UE-B selects a resource(s) by sensing, and transmits SL data to UE-A on the resource(s). UE-B and UE-C are far from each other, UE-B cannot sense transmission of UE-C, and UE-C cannot sense transmission of UE-B, so that UE-B and UE-C may select the same transmission resource. In this case, data transmission by UE-C may interfere with data transmission by UE-B. This is a problem of hidden nodes.
2. Problem generated due to half duplex: due to limitation of half duplex, when the terminal transmits SL data in a slot in a sensing window, the terminal cannot receive in the slot data transmitted by other terminals, so that when the terminal performs sensing to select a transmission resource(s), there is no sensing result. Therefore, when performing resource exclusion, the terminal may exclude from a selection window all resources corresponding to the slot in the sensing window to avoid interference with other terminals. Due to limitation of half duplex, many resources are unnecessarily excluded by the terminal.
3. Problem generated due to exposed terminals: as illustrated in FIG. 12 below, transmitting UE-B and transmitting UE-C can sense each other, but target receiving UE-A of transmitting UE-B is far from transmitting UE-C, and target receiving UE-D of transmitting UE-C is far from transmitting UE-B. In this case, even though transmitting UE-B and transmitting UE-C use the same time-frequency resource, reception by the target receiving terminal of transmitting UE-B and reception by the target receiving terminal of transmitting UE-C may not be affected. However, since transmitting UE-B and transmitting UE-C are close to each other in geographic location, transmitting UE-B and transmitting UE-C may both detect relatively high signal received power during sensing. As a result, a time-frequency resource selected by transmitting UE-B and a time-frequency resource selected by transmitting UE-C may be orthogonal, which may degrade resource utilization efficiency.
4. Power-consumption problem: in the above sensing procedure, the terminal needs to perform resource sensing contiguously to determine which resources are available, which may cause high power consumption. This does not matter for an in-vehicle terminal because the in-vehicle terminal is equipped with a power supply device. However, for a handheld terminal, excessive power consumption will result in power-off of the terminal soon. Therefore, how to reduce power consumption of the terminal is also a problem that needs to be taken into consideration during resource selection.

Due to the above problems that occur during resource selection in mode 2, an enhanced resource-selection scheme is proposed. Based on the resource sensing used in mode 2, a terminal device (UE-A) may transmit coordination information to another terminal device (UE-B) to assist UE-B in resource selection.

In some embodiments, the coordination information may include the following two types: type 1 and type 2.
Type 1: when UE-A receives an explicit request from UE-B or satisfies a specific condition, UE-A can acquire a resource set according to a resource sensing result, an indication of a base station, and the like, and transmit the resource set to UE-B. The resource set may be a resource set suitable for use by UE-B. In this case, when UE-B selects a resource(s) for transmitting SL data to a target receiving terminal, UE-B may preferentially select a resource(s) from the available resource set, thereby improving reliability in reception of the SL data by the target receiving terminal. Alternatively, the resource set may also be a resource set unsuitable for use by UE-B. In this case, during source selection, UE-B can avoid selecting a resource(s) from the resource set, thereby avoiding occurrence of problems of hidden terminals and limitation of half duplex.
Type 2: information transmitted by UE-A to UE-B indicates that resources reserved by UE-B include resources that may cause collision. UE-B will perform resource re-selection on the resources that may cause collision.

Compared with mode 2 in which the terminal autonomously selects a transmission resource(s), the enhanced resource-allocation mode described above, in which the terminal performs resource selection based on assistance information transmitted by other terminals, can improve reliability of transmission.

In type 1 of the enhanced resource-selection scheme, the resource set transmitted by UE-A may contain resources suitable for use by UE-B or resources unsuitable for use by UE-B. However, how UE-A determines which type of resource set needs to be transmitted is an unsolved problem.

Based on the above problems, a resource-selection scheme is provided in the disclosure. A first terminal device can determine type information of resources in a target resource set to be provided to a second terminal device. The target resource set contains at least one of: a type of resources suitable for use by the second terminal device or a type of resources unsuitable for use by the second terminal device. In this way, the second terminal device can perform resource selection based on the target resource set, thereby improving reliability of transmission.

Technical solutions of the disclosure will be described in detail below in connection with embodiments.

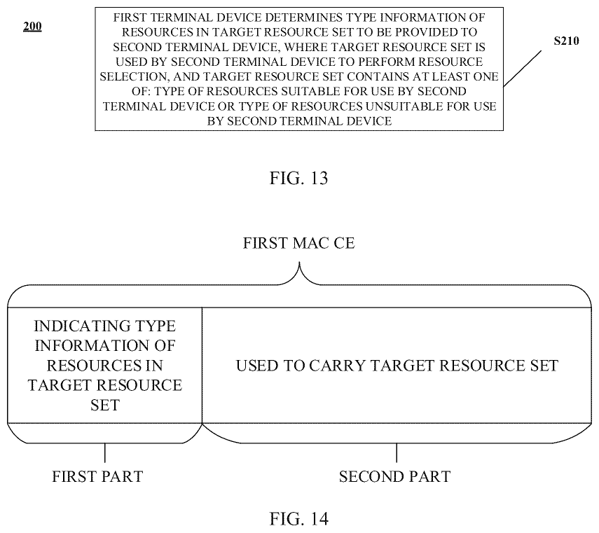

FIG. 13 is a schematic flow chart of a method 200 for wireless communication according to embodiments of the disclosure. As illustrated in FIG. 13, the method 200 for wireless communication may include at least part of the following.

At S210, a first terminal device determines type information of resources in a target resource set to be provided to a second terminal device. The target resource set is used by the second terminal device to perform resource selection. The target resource set contains at least one of: a type of resources suitable for use by the second terminal device or a type of resources unsuitable for use by the second terminal device.

In embodiments of the disclosure, the first terminal device may acquire the target resource set according to a resource sensing result. Alternatively, the first terminal device may acquire the target resource set according to an indication of a network device. In addition, the first terminal device may also acquire the target resource set in other manners, which is not limited in the disclosure.

In some embodiments, the first terminal device may determine, according to whether the second terminal device is allowed to directly perform transmission resource selection from the resource set to be provided by the first terminal device, the type information of the resources in the target resource set to be provided to the second terminal device. That is, at S210, specifically, the first terminal device may determine, according to whether the second terminal device is allowed to directly perform transmission resource selection from the resource set to be provided by the first terminal device, the type information of the resources in the target resource set to be provided to the second terminal device.

In some embodiments, in a case where the second terminal device is allowed to directly perform transmission resource selection from the resource set to be provided by the first terminal device, the first terminal device determines that the target resource set contains the type of resources suitable for use by the second terminal device.

In some embodiments, in a case where the second terminal device is not allowed to directly perform transmission resource selection from the resource set to be provided by the first terminal device, the first terminal device determines that the target resource set contains the type of resources unsuitable for use by the second terminal device.

In some embodiments, the second terminal device is allowed to directly perform transmission resource selection from the resource set to be provided by the first terminal device, in a case where at least one of the following conditions is satisfied. The second terminal device does not support channel sensing. The second terminal device performs resource selection by partial sensing and the second terminal device has triggered resource re-selection. A resource pool for the second terminal device allows random resource selection. The second terminal device performs resource selection via random selection. The second terminal device performs resource selection by partial sensing and the second terminal device is unable to ensure that a monitoring window contains M contiguous slots, where M is a positive integer.

In some embodiments, a value of M is pre-configured or agreed by a protocol, or the value of M is configured by a network device.

Specifically, for example, due to arrival of a new data packet, or due to resource pre-emption or re-evaluation, the second terminal device has no periodic based partial sensing result. In this case, the second terminal device triggers resource re-selection. That is, the second terminal device performs resource selection by partial sensing, but due to arrival of a new data packet, or due to resource pre-emption or re-evaluation, the second terminal device has no periodic based partial sensing result, so that the second terminal device triggers resource re-selection.

Specifically, for example, the second terminal device performs resource selection by contiguous partial sensing, and the second terminal device is unable to ensure that a monitoring window contains M contiguous slots. M is a specific value, which is configured by a network device, pre-configured, or agreed by a protocol. For example, a default value of M is agreed as 31 by a protocol.

In some embodiments, the first terminal device receives first indication information from the second terminal device. The first terminal device may determine, based on the first indication information, whether the second terminal device is allowed to directly perform transmission resource selection from the resource set to be provided by the first terminal device.

In some embodiments, the first indication information indicates that the second terminal device is allowed to directly perform transmission resource selection from the resource set to be provided by the first terminal device. That is, the first terminal device may determine, based on the first indication information, that the second terminal device is allowed to directly perform transmission resource selection from the resource set to be provided by the first terminal device.

In some embodiments, the first indication information indicates that the second terminal device satisfies at least one of the following conditions. The second terminal device does not support channel sensing. The second terminal device performs resource selection by partial sensing and the second terminal device has triggered resource re-selection. A resource pool for the second terminal device allows random resource selection. The second terminal device performs resource selection via random selection. The second terminal device performs resource selection by partial sensing and the second terminal device is unable to ensure that a monitoring window contains M contiguous slots, where M is a positive integer.

In some embodiments, the second terminal device may transmit the first indication information through proximity-based service communication interface 5 (PC5)-radio resource control (RRC) signaling. That is, in a case where a PC5-RRC link exists between the first terminal device and the second terminal device, the first indication information may be carried in the PC5-RRC signaling.

In some embodiments, the first terminal device determines, according to resources acquired by the first terminal device, the type information of the resources in the target resource set to be provided to the second terminal device. That is, at S210, specifically, the first terminal device may determine, according to the resources acquired by the first terminal device, the type information of the resources in the target resource set to be provided to the second terminal device.

For example, in a case where resources suitable for use by the second terminal device are acquired by the first terminal device, the first terminal device determines that the target resource set to be provided to the second terminal device contains the type of resources suitable for use by the second terminal device.

For another example, in a case where resources unsuitable for use by the second terminal device are acquired by the first terminal device, the first terminal device determines that the target resource set to be provided to the second terminal device contains the type of resources unsuitable for use by the second terminal device.

For yet another example, in a case where resources suitable for use by the second terminal device and resources unsuitable for use by the second terminal device are acquired by the first terminal device, the first terminal device determines that the target resource set to be provided to the second terminal device contains the type of resources suitable for use by the second terminal device and the type of resources unsuitable for use by the second terminal device.

In some embodiments, the target resource set is carried in first information. In other words, the first terminal device transmits the first information to the second terminal device, where the first information contains the target resource set. For example, the first information may be coordination information.

In some embodiments, the first information contains at least one information bit, and the at least one information bit indicates the type information of the resources in the target resource set. Alternatively, the first information contains at least one parameter, and the at least one parameter indicates the type information of the resources in the target resource set.

In some embodiments, in a case where the target resource set only contains one type of resources (suitable for use by the second terminal device or unsuitable for use by the second terminal device), and the first information is carried in a first media access control control element (MAC CE), the first MAC CE contains a first part and a second part. The first part indicates the type information of the resources in the target resource set, and the second part is used to carry the target resource set.

Specifically, for example, the first information is carried in the first MAC CE. As illustrated in FIG. 14, the first MAC CE contains two parts. The first part indicates the type information (suitable for use by the second terminal device or unsuitable for use by the second terminal device) of the resources in the target resource set. The second part is used to carry the target resource set.

In some embodiments, in a case where the target resource set contains two types of resources and the first information is carried in a second MAC CE, the second MAC CE contains a first part and a second part. The first part is used to carry resources suitable for use by the second terminal device, and the second part is used to carry resources unsuitable for use by the second terminal device. Specifically, a first sub-part of the first part indicates the number of resources suitable for use by the second terminal device in the target resource set, and a second sub-part of the first part is used to carry the resources suitable for use by the second terminal device; and/or, a first sub-part of the second part indicates the number of resources unsuitable for use by the second terminal device in the target resource set, and a second sub-part of the second part is used to carry the resources unsuitable for use by the second terminal device.

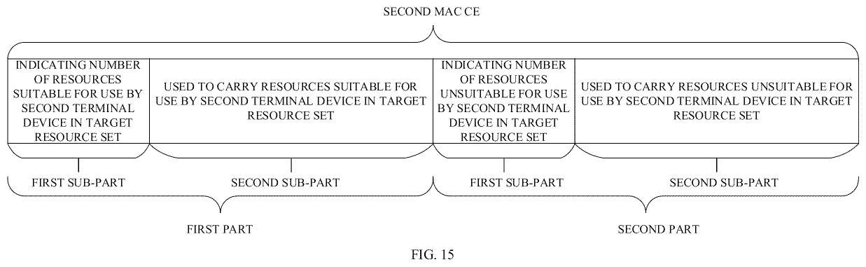

Specifically, for example, the first information is carried in the second MAC CE. As illustrated in FIG. 15, the second MAC CE contains two parts. The first part is used to carry the resources suitable for use by the second terminal device, and the second part is used to carry the resources unsuitable for use by the second terminal device. In addition, each of the two parts is further divided into two sub-parts, where for each of the two parts, the first sub-part indicates the number of resources in the part, and the other sub-part is used to carry corresponding resources. The first part or the second part may carry no resource.

In some embodiments, the first terminal device determines, according to second indication information transmitted by the second terminal device, the type information of the resources in the target resource set to be provided to the second terminal device. The second indication information instructs the first terminal device to provide resources suitable for use by the second terminal device. Alternatively, the second indication information instructs the first terminal device to provide resources unsuitable for use by the second terminal device. That is, at S210, specifically, the first terminal device may determine, according to an indication from the second terminal device, the type information of the resources in the target resource set to be provided to the second terminal device.

In some embodiments, in a case where the second terminal device is allowed to directly perform transmission resource selection from the resource set to be provided by the first terminal device, the second indication information instructs the first terminal device to provide the resources suitable for use by the second terminal device.

In some embodiments, in a case where the second terminal device is not allowed to directly perform transmission resource selection from the resource set to be provided by the first terminal device, the second indication information instructs the first terminal device to provide the resources unsuitable for use by the second terminal device.

In some embodiments, the second indication information is carried in coordination information request signaling. Alternatively, the second indication information is carried in PC5-RRC signaling. Alternatively, the second indication information is carried in SCI.

For example, the second terminal device indicates, via a certain reserved bit in first-stage SCI, the type information of resources required to be provided by the first terminal device. For another example, the second terminal device indicates, via a certain bit in second-stage SCI, the type information of resources required to be provided by the first terminal device.

In some embodiments, the first terminal device may determine, according to whether the first terminal device is a target receiver of the second terminal device, the type information of the resources in the target resource set to be provided to the second terminal device. That is, at S210, specifically, the first terminal device may determine, according to whether the first terminal device is the target receiver of the second terminal device, the type information of the resources in the target resource set to be provided to the second terminal device. Specifically, this embodiment is merely used for the case where transmission of the target resource set is event-triggered, that is, the target resource set is transmitted by the first terminal device in a case where an event-based triggering condition is satisfied.

Specifically, for example, a triggering event may be an event that the first terminal device determines that a resource(s) reserved by the second terminal device overlaps a resource(s) unsuitable for use by the second terminal device. That is, in a case where the first terminal device determines that the resource(s) reserved by the second terminal device overlaps the resource(s) unsuitable for use by the second terminal device, the first terminal device may provide the target resource set to the second terminal device. In addition, the triggering event may also be other events, which is not limited in the disclosure.

In some embodiments, in a case where the first terminal device is the target receiver of the second terminal device, the first terminal device determines that the target resource set contains the type of resources suitable for use by the second terminal device, or the first terminal device determines that the target resource set contains the type of resources unsuitable for use by the second terminal device, or the first terminal device determines that the target resource set contains the type of resources suitable for use by the second terminal device and the type of resources unsuitable for use by the second terminal device.

In some embodiments, in a case where the first terminal device is not the target receiver of the second terminal device, the first terminal device determines that the target resource set contains the type of resources unsuitable for use by the second terminal device.

In some embodiments, the first terminal device determines, according to resource-pool configuration information of a first resource pool, the type information of the resources in the target resource set to be provided to the second terminal device. The resource-pool configuration information indicates type information of resources to be provided by the first terminal device to the second terminal device. The first resource pool is a resource pool from which the first terminal device selects resources to be transmitted to the second terminal device. That is, at S210, specifically, the first terminal device may determine, according to the resource-pool configuration information of the first resource pool, the type information of the resources in the target resource set to be provided to the second terminal device. Specifically, for example, the resource-pool configuration information may configure the first terminal device to merely provide one type of resources. Alternatively, the resource-pool configuration information may configure the first terminal device to provide two types of resources. Optionally, the resource-pool configuration information may be semi-static configuration information.

In some embodiments, in a case where the resource-pool configuration information indicates that the first terminal device is only allowed to provide resources unsuitable for use by the second terminal device, the first terminal device determines that the target resource set contains the type of resources unsuitable for use by the second terminal device. In other words, in a case where the resource-pool configuration information indicates that the first terminal device is only allowed to provide the resources unsuitable for use by the second terminal device, the first terminal device is not allowed to provide resources suitable for use by the second terminal device.

In some embodiments, in a case where the resource-pool configuration information indicates that the first terminal device is only allowed to provide resources unsuitable for use by the second terminal device, and in a case where the second terminal device is allowed to directly perform transmission resource selection from the resource set to be provided by the first terminal device, the first terminal device determines that the target resource set contains the type of resources suitable for use by the second terminal device and/or the type of resources unsuitable for use by the second terminal device. In other words, in a case where the resource-pool configuration information indicates that the first terminal device is only allowed to provide the resources unsuitable for use by the second terminal device, and in a case where the second terminal device is allowed to directly select a resource for transmission from the resource set to be provided by the first terminal device, the first terminal device is allowed to provide the resources suitable for use by the second terminal device, and the first terminal device may also provide the type of resources unsuitable for use by the second terminal device.

In some embodiments, in a case where the resource-pool configuration information indicates that the first terminal device is only allowed to provide resources unsuitable for use by the second terminal device, and in a case where the second terminal device is not allowed to directly perform transmission resource selection from the resource set to be provided by the first terminal device, the first terminal device determines that the target resource set contains the type of resources unsuitable for use by the second terminal device. In other words, in a case where the resource-pool configuration information indicates that the first terminal device is only allowed to provide the resources unsuitable for use by the second terminal device, and in a case where the second terminal device is not allowed to directly select a resource for transmission from the resource set to be provided by the first terminal device, the first terminal device is not allowed to provide the resources suitable for use by the second terminal device.

In some embodiments, in a case where the resource-pool configuration information indicates that the first terminal device is only allowed to provide resources suitable for use by the second terminal device, the first terminal device determines that the target resource set contains the type of resources suitable for use by the second terminal device. In other words, in a case where the resource-pool configuration information indicates that the first terminal device is only allowed to provide the resources suitable for use by the second terminal device, the first terminal device is not allowed to provide the resources unsuitable for use by the second terminal device.

In some embodiments, in a case where the resource-pool configuration information indicates that the first terminal device is only allowed to provide resources suitable for use by the second terminal device, and in a case where the first terminal device is not a target receiver of the second terminal device, the first terminal device determines that the target resource set contains the type of resources suitable for use by the second terminal device and/or the type of resources unsuitable for use by the second terminal device. In other words, in a case where the resource-pool configuration information indicates that the first terminal device is only allowed to provide the resources suitable for use by the second terminal device, and in a case where the first terminal device is not the target receiver of the second terminal device, the first terminal device is allowed to provide the resources unsuitable for use by the second terminal device, and the first terminal device may also provide the resources suitable for use by the second terminal device.

In some embodiments, in a case where the resource-pool configuration information indicates that the first terminal device is only allowed to provide resources suitable for use by the second terminal device, and in a case where the first terminal device is a target receiver of the second terminal device, the first terminal device determines that the target resource set contains the type of resources suitable for use by the second terminal device. In other words, in a case where the resource-pool configuration information indicates that the first terminal device is only allowed to provide the resources suitable for use by the second terminal device, and in a case where the first terminal device is the target receiver of the second terminal device, the first terminal device is not allowed to provide the resources unsuitable for use by the second terminal device.

Therefore, in embodiments of the disclosure, the first terminal device can determine the type information of the resources in the target resource set to be provided to the second terminal device. The target resource set contains at least one of: the type of resources suitable for use by the second terminal device or the type of resources unsuitable for use by the second terminal device. In this way, the second terminal device can perform resource selection based on the target resource set, thereby improving reliability of transmission.

In embodiments of the disclosure, in a case where the second terminal device can directly perform resource selection from the resource set to be provided by the first terminal device, the target resource set to be provided by the first terminal device may contain the resources suitable for use by the second terminal device, and otherwise, the target resource set to be provided by the first terminal device may contain the resources unsuitable for use by the second terminal device. Alternatively, the first terminal device determines to provide to the second terminal device the resources suitable for use by the second terminal device or the resources unsuitable for use by the second terminal device. Alternatively, the second terminal device instructs the first terminal device to provide the resources suitable for use by the second terminal device or the resources unsuitable for use by the second terminal device. Alternatively, for the event-triggered transmission of the target resource set, in a case where the first terminal device is not the target receiver of the second terminal device, the first terminal device can merely transmit the resources unsuitable for use by the second terminal device, and in a case where the first terminal device is the target receiver of the second terminal device, the first terminal device can transmit the resources suitable or unsuitable for use by the second terminal device. Alternatively, which type of resources is required to be provided into a resource pool is semi-statically configured through resource-pool configuration signaling. In embodiments of the disclosure, various information (i.e., coordination information) carrying the target resource set can be flexibly transmitted, thereby ensuring that source selection on an SL based on inter-UE coordination information can operate efficiently, and improving the overall performance of the SL.

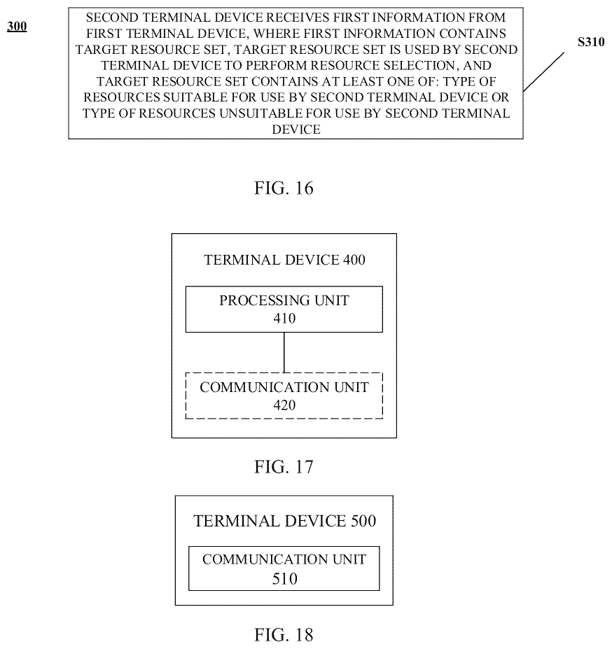

The embodiments of the disclosure at the first terminal device side are described in detail above with reference to FIG. 13 to FIG. 15, and embodiments of the disclosure at the second terminal device side will be described in detail below with reference to FIG. 16. It may be understood that, the embodiments at the second terminal device side correspond to the embodiments at the first terminal device side, and for similar illustrations, reference can be made to the embodiments at the first terminal device side.

FIG. 16 is a schematic flow chart of a method 300 for wireless communication according to embodiments of the disclosure. As illustrated in FIG. 16, the method 300 for wireless communication may include at least part of the following.

At S310, a second terminal device receives first information from a first terminal device. The first information contains a target resource set, and the target resource set is used by the second terminal device to perform resource selection. The target resource set contains at least one of: a type of resources suitable for use by the second terminal device or a type of resources unsuitable for use by the second terminal device.

In some embodiments, in a case where the second terminal device is allowed to directly perform transmission resource selection from the resource set to be provided by the first terminal device, the target resource set contains the type of resources suitable for use by the second terminal device.

In some embodiments, in a case where the second terminal device is not allowed to directly perform transmission resource selection from the resource set to be provided by the first terminal device, the target resource set contains the type of resources unsuitable for use by the second terminal device.

In some embodiments, the second terminal device is allowed to directly perform transmission resource selection from the resource set to be provided by the first terminal device, in a case where at least one of the following conditions is satisfied. The second terminal device does not support channel sensing. The second terminal device performs resource selection by partial sensing and the second terminal device has triggered resource re-selection. A resource pool for the second terminal device allows random resource selection. The second terminal device performs resource selection via random selection. The second terminal device performs resource selection by partial sensing and the second terminal device is unable to ensure that a monitoring window contains M contiguous slots, where M is a positive integer.

In some embodiments, the second terminal device transmits first indication information to the first terminal device. The first terminal device may determine, based on the first indication information, whether the second terminal device is allowed to directly perform transmission resource selection from the resource set to be provided by the first terminal device.

In some embodiments, the first indication information indicates that the second terminal device is allowed to directly perform transmission resource selection from the resource set to be provided by the first terminal device. That is, the first terminal device may determine, based on the first indication information, that the second terminal device is allowed to directly perform transmission resource selection from the resource set to be provided by the first terminal device.

In some embodiments, the first indication information indicates that the second terminal device satisfies at least one of the following conditions. The second terminal device does not support channel sensing. The second terminal device performs resource selection by partial sensing and the second terminal device has triggered resource re-selection. A resource pool for the second terminal device allows random resource selection. The second terminal device performs resource selection via random selection. The second terminal device performs resource selection by partial sensing and the second terminal device is unable to ensure that a monitoring window contains M contiguous slots, where M is a positive integer.

In some embodiments, the second terminal device may transmit the first indication information through PC5-RRC signaling. That is, in a case where a PC5-RRC link exists between the first terminal device and the second terminal device, the first indication information may be carried in the PC5-RRC signaling.

In some embodiments, the type information of the resources in the target resource set is determined based on resources acquired by the first terminal device. That is, specifically, the first terminal device may determine, according to the resources acquired by the first terminal device, the type information of the resources in the target resource set to be provided to the second terminal device.

For example, in a case where resources suitable for use by the second terminal device are acquired by the first terminal device, the first terminal device determines that the target resource set to be provided to the second terminal device contains the type of resources suitable for use by the second terminal device.

For another example, in a case where resources unsuitable for use by the second terminal device are acquired by the first terminal device, the first terminal device determines that the target resource set to be provided to the second terminal device contains the type of resources unsuitable for use by the second terminal device.

For yet another example, in a case where resources suitable for use by the second terminal device and resources unsuitable for use by the second terminal device are acquired by the first terminal device, the first terminal device determines that the target resource set to be provided to the second terminal device contains the type of resources suitable for use by the second terminal device and the type of resources unsuitable for use by the second terminal device.

In some embodiments, the first information contains at least one information bit, and the at least one information bit indicates the type information of the resources in the target resource set. Alternatively, the first information contains at least one parameter, and the at least one parameter indicates the type information of the resources in the target resource set.

In some embodiments, in a case where the target resource set only contains one type of resources and the first information is carried in a first MAC CE, the first MAC CE contains a first part and a second part. The first part indicates the type information of the resources in the target resource set, and the second part is used to carry the target resource set.

In some embodiments, in a case where the target resource set contains two types of resources and the first information is carried in a second MAC CE, the second MAC CE contains a first part and a second part. The first part is used to carry resources suitable for use by the second terminal device, and the second part is used to carry resources unsuitable for use by the second terminal device. In some embodiments, a first sub-part of the first part indicates the number of resources suitable for use by the second terminal device in the target resource set, and a second sub-part of the first part is used to carry the resources suitable for use by the second terminal device; and/or, a first sub-part of the second part indicates the number of resources unsuitable for use by the second terminal device in the target resource set, and a second sub-part of the second part is used to carry the resources unsuitable for use by the second terminal device.

In some embodiments, the type information of the resources in the target resource set is determined based on second indication information transmitted by the second terminal device. The second indication information instructs the first terminal device to provide resources suitable for use by the second terminal device. Alternatively, the second indication information instructs the first terminal device to provide resources unsuitable for use by the second terminal device.

In some embodiments, in a case where the second terminal device is allowed to directly perform transmission resource selection from the resource set to be provided by the first terminal device, the second indication information instructs the first terminal device to provide the resources suitable for use by the second terminal device; and/or in a case where the second terminal device is not allowed to directly perform transmission resource selection from the resource set to be provided by the first terminal device, the second indication information instructs the first terminal device to provide the resources unsuitable for use by the second terminal device.

In some embodiments, the second indication information is carried in coordination information request signaling. Alternatively, the second indication information is carried in PC5-RRC signaling. Alternatively, the second indication information is carried in SCI.

In some embodiments, in a case where the first terminal device is a target receiver of the second terminal device, the target resource set contains the type of resources suitable for use by the second terminal device, or the target resource set contains the type of resources unsuitable for use by the second terminal device, or the target resource set contains the type of resources suitable for use by the second terminal device and the type of resources unsuitable for use by the second terminal device; and/or in a case where the first terminal device is not a target receiver of the second terminal device, the target resource set contains the type of resources unsuitable for use by the second terminal device. In some embodiments, the target resource set is transmitted by the first terminal device in a case where an event-based triggering condition is satisfied.

In some embodiments, the type information of the resources in the target resource set is determined based on resource-pool configuration information of a first resource pool. The resource-pool configuration information indicates type information of resources to be provided by the first terminal device to the second terminal device. The first resource pool is a resource pool from which the first terminal device selects resources to be transmitted to the second terminal device.

In some embodiments, in a case where the resource-pool configuration information indicates that the first terminal device is only allowed to provide resources unsuitable for use by the second terminal device, the target resource set contains the type of resources unsuitable for use by the second terminal device.

In some embodiments, in a case where the resource-pool configuration information indicates that the first terminal device is only allowed to provide resources unsuitable for use by the second terminal device, and in a case where the second terminal device is allowed to directly perform transmission resource selection from the resource set to be provided by the first terminal device, the target resource set contains the type of resources suitable for use by the second terminal device and/or the type of resources unsuitable for use by the second terminal device.

In some embodiments, in a case where the resource-pool configuration information indicates that the first terminal device is only allowed to provide resources unsuitable for use by the second terminal device, and in a case where the second terminal device is not allowed to directly perform transmission resource selection from the resource set to be provided by the first terminal device, the target resource set contains the type of resources unsuitable for use by the second terminal device.

In some embodiments, in a case where the resource-pool configuration information indicates that the first terminal device is only allowed to provide resources suitable for use by the second terminal device, the target resource set contains the type of resources suitable for use by the second terminal device.

In some embodiments, in a case where the resource-pool configuration information indicates that the first terminal device is only allowed to provide resources suitable for use by the second terminal device, and in a case where the first terminal device is not a target receiver of the second terminal device, the target resource set contains the type of resources suitable for use by the second terminal device and/or the type of resources unsuitable for use by the second terminal device.

In some embodiments, in a case where the resource-pool configuration information indicates that the first terminal device is only allowed to provide resources suitable for use by the second terminal device, and in a case where the first terminal device is a target receiver of the second terminal device, the target resource set contains the type of resources suitable for use by the second terminal device.

In some embodiments, the resource-pool configuration information is semi-static configuration information.

Therefore, in embodiments of the disclosure, the first terminal device can determine the type information of the resources in the target resource set to be provided to the second terminal device. The target resource set contains at least one of: the type of resources suitable for use by the second terminal device or the type of resources unsuitable for use by the second terminal device. In this way, the second terminal device can perform resource selection based on the target resource set, thereby improving reliability of transmission.

The method embodiments of the disclosure are described in detail above with reference to FIG. 13 to FIG. 16, and apparatus embodiments of the disclosure will be described in detail below with reference to FIG. 17 to FIG. 21. It may be understood that, the apparatus embodiments correspond to the method embodiments, and for similar illustrations, reference can be made to the method embodiments.

FIG. 17 illustrates a schematic block diagram of a terminal device 400 according to embodiments of the disclosure. The terminal device 400 is a first terminal device. As illustrated in FIG. 17, the terminal device 400 includes a processing unit 410. The processing unit 410 is configured to determine type information of resources in a target resource set to be provided to a second terminal device. The target resource set is used by the second terminal device to perform resource selection. The target resource set contains at least one of: a type of resources suitable for use by the second terminal device or a type of resources unsuitable for use by the second terminal device.

In some embodiments, the processing unit 410 is specifically configured to determine that the target resource set contains the type of resources suitable for use by the second terminal device, in a case where the second terminal device is allowed to directly perform transmission resource selection from the resource set to be provided by the first terminal device; and/or determine that the target resource set contains the type of resources unsuitable for use by the second terminal device, in a case where the second terminal device is not allowed to directly perform transmission resource selection from the resource set to be provided by the first terminal device.

In some embodiments, the second terminal device is allowed to directly perform transmission resource selection from the resource set to be provided by the first terminal device, in a case where at least one of the following conditions is satisfied. The second terminal device does not support channel sensing. The second terminal device performs resource selection by partial sensing and the second terminal device has triggered resource re-selection. A resource pool for the second terminal device allows random resource selection. The second terminal device performs resource selection via random selection. The second terminal device performs resource selection by partial sensing and the second terminal device is unable to ensure that a monitoring window contains M contiguous slots, where M is a positive integer.

In some embodiments, the terminal device 400 further includes a communication unit 420. The communication unit 420 is configured to receive first indication information from the second terminal device. The first indication information indicates that the second terminal device is allowed to directly perform transmission resource selection from the resource set to be provided by the first terminal device. Alternatively, the first indication information indicates that the second terminal device satisfies at least one of the following conditions. The second terminal device does not support channel sensing. The second terminal device performs resource selection by partial sensing and the second terminal device has triggered resource re-selection. A resource pool for the second terminal device allows random resource selection. The second terminal device performs resource selection via random selection. The second terminal device performs resource selection by partial sensing and the second terminal device is unable to ensure that a monitoring window contains M contiguous slots, where M is a positive integer.

In some embodiments, a value of M is pre-configured or agreed by a protocol, or the value of M is configured by a network device.

In some embodiments, the processing unit 410 is specifically configured to determine, according to resources acquired by the first terminal device, the type information of the resources in the target resource set to be provided to the second terminal device.

In some embodiments, the target resource set is carried in first information. The first information contains at least one information bit, and the at least one information bit indicates the type information of the resources in the target resource set. Alternatively, the first information contains at least one parameter, and the at least one parameter indicates the type information of the resources in the target resource set.

In some embodiments, in a case where the target resource set only contains one type of resources and the first information is carried in a first MAC CE, the first MAC CE contains a first part and a second part. The first part indicates the type information of the resources in the target resource set, and the second part is used to carry the target resource set.

In some embodiments, in a case where the target resource set contains two types of resources and the first information is carried in a second MAC CE, the second MAC CE contains a first part and a second part. The first part is used to carry resources suitable for use by the second terminal device, and the second part is used to carry resources unsuitable for use by the second terminal device.

In some embodiments, a first sub-part of the first part indicates the number of resources suitable for use by the second terminal device in the target resource set, and a second sub-part of the first part is used to carry the resources suitable for use by the second terminal device; and/or, a first sub-part of the second part indicates the number of resources unsuitable for use by the second terminal device in the target resource set, and a second sub-part of the second part is used to carry the resources unsuitable for use by the second terminal device.

In some embodiments, the processing unit 410 is specifically configured to determine, according to second indication information transmitted by the second terminal device, the type information of the resources in the target resource set to be provided to the second terminal device. The second indication information instructs the first terminal device to provide resources suitable for use by the second terminal device. Alternatively, the second indication information instructs the first terminal device to provide resources unsuitable for use by the second terminal device.

In some embodiments, in a case where the second terminal device is allowed to directly perform transmission resource selection from the resource set to be provided by the first terminal device, the second indication information instructs the first terminal device to provide the resources suitable for use by the second terminal device; and/or in a case where the second terminal device is not allowed to directly perform transmission resource selection from the resource set to be provided by the first terminal device, the second indication information instructs the first terminal device to provide the resources unsuitable for use by the second terminal device.

In some embodiments, the second indication information is carried in coordination information request signaling. Alternatively, the second indication information is carried in PC5-RRC signaling. Alternatively, the second indication information is carried in SCI.

In some embodiments, the processing unit 410 is specifically configured to determine that the target resource set contains the type of resources suitable for use by the second terminal device, or determine that the target resource set contains the type of resources unsuitable for use by the second terminal device, or determine that the target resource set contains the type of resources suitable for use by the second terminal device and the type of resources unsuitable for use by the second terminal device, in a case where the first terminal device is the target receiver of the second terminal device; and/or determine that the target resource set contains the type of resources unsuitable for use by the second terminal device, in a case where the first terminal device is not the target receiver of the second terminal device.

In some embodiments, the target resource set is transmitted by the first terminal device in a case where an event-based triggering condition is satisfied.

In some embodiments, the processing unit 410 is specifically configured to determine, according to resource-pool configuration information of a first resource pool, the type information of the resources in the target resource set to be provided to the second terminal device. The resource-pool configuration information indicates type information of resources to be provided by the first terminal device to the second terminal device. The first resource pool is a resource pool from which the first terminal device selects resources to be transmitted to the second terminal device.

In some embodiments, the processing unit 410 is specifically configured to determine that the target resource set contains the type of resources unsuitable for use by the second terminal device, in a case where the resource-pool configuration information indicates that the first terminal device is only allowed to provide resources unsuitable for use by the second terminal device. Alternatively, the processing unit 410 is further configured to determine that the target resource set contains the type of resources suitable for use by the second terminal device and/or the type of resources unsuitable for use by the second terminal device, in a case where the resource-pool configuration information indicates that the first terminal device is only allowed to provide resources unsuitable for use by the second terminal device, and in a case where the second terminal device is allowed to directly perform transmission resource selection from the resource set to be provided by the first terminal device. Alternatively, the processing unit 410 is further configured to determine that the target resource set contains the type of resources unsuitable for use by the second terminal device, in a case where the resource-pool configuration information indicates that the first terminal device is only allowed to provide resources unsuitable for use by the second terminal device, and in a case where the second terminal device is not allowed to directly perform transmission resource selection from the resource set to be provided by the first terminal device.

In some embodiments, the processing unit 410 is specifically configured to determine that the target resource set contains the type of resources suitable for use by the second terminal device, in a case where the resource-pool configuration information indicates that the first terminal device is only allowed to provide resources suitable for use by the second terminal device. Alternatively, the processing unit 410 is further configured to determine that the target resource set contains the type of resources suitable for use by the second terminal device and/or the type of resources unsuitable for use by the second terminal device, in a case where the resource-pool configuration information indicates that the first terminal device is only allowed to provide resources suitable for use by the second terminal device, and in a case where the first terminal device is not a target receiver of the second terminal device. Alternatively, the processing unit 410 is further configured to determine that the target resource set contains the type of resources suitable for use by the second terminal device, in a case where the resource-pool configuration information indicates that the first terminal device is only allowed to provide resources suitable for use by the second terminal device, and in a case where the first terminal device is a target receiver of the second terminal device.

In some embodiments, the resource-pool configuration information is semi-static configuration information.

In some embodiments, the communication unit above may be a communication interface or a transceiver, or may be an input/output interface of a communication chip or an SoC. The processing unit above may be one or more processors.

It may be understood that, the terminal device 400 according to embodiments of the disclosure may correspond to the first terminal device in the method embodiments of the disclosure, and the foregoing and other operations and/or functions of various units in the terminal device 400 are respectively intended for implementing corresponding procedures of the first terminal device in the method 200 illustrated in FIG. 13, which will not be repeated herein for the sake of simplicity.

FIG. 18 illustrates a schematic block diagram of a terminal device 500 according to embodiments of the disclosure. The terminal device 500 is a second terminal device. As illustrated in FIG. 18, the terminal device 500 includes a communication unit 510. The communication unit 510 is configured to receive first information from a first terminal device. The first information contains a target resource set, and the target resource set is used by the second terminal device to perform resource selection. The target resource set contains at least one of: a type of resources suitable for use by the second terminal device or a type of resources unsuitable for use by the second terminal device.

In some embodiments, in a case where the second terminal device is allowed to directly perform transmission resource selection from the resource set to be provided by the first terminal device, the target resource set contains the type of resources suitable for use by the second terminal device; and/or in a case where the second terminal device is not allowed to directly perform transmission resource selection from the resource set to be provided by the first terminal device, the target resource set contains the type of resources unsuitable for use by the second terminal device.

In some embodiments, the second terminal device is allowed to directly perform transmission resource selection from the resource set to be provided by the first terminal device, in a case where at least one of the following conditions is satisfied. The second terminal device does not support channel sensing. The second terminal device performs resource selection by partial sensing and the second terminal device has triggered resource re-selection. A resource pool for the second terminal device allows random resource selection. The second terminal device performs resource selection via random selection. The second terminal device performs resource selection by partial sensing and the second terminal device is unable to ensure that a monitoring window contains M contiguous slots, where M is a positive integer.

In some embodiments, the communication unit 510 is further configured to transmit first indication information to the first terminal device. The first indication information indicates that the second terminal device is allowed to directly perform transmission resource selection from the resource set to be provided by the first terminal device. Alternatively, the first indication information indicates that the second terminal device satisfies at least one of the following conditions. The second terminal device does not support channel sensing. The second terminal device performs resource selection by partial sensing and the second terminal device has triggered resource re-selection. A resource pool for the second terminal device allows random resource selection. The second terminal device performs resource selection via random selection. The second terminal device performs resource selection by partial sensing and the second terminal device is unable to ensure that a monitoring window contains M contiguous slots, where M is a positive integer.

In some embodiments, a value of M is pre-configured or agreed by a protocol, or the value of M is configured by a network device.

In some embodiments, the type information of the resources in the target resource set is determined based on resources acquired by the first terminal device.

In some embodiments, the first information contains at least one information bit, and the at least one information bit indicates the type information of the resources in the target resource set. Alternatively, the first information contains at least one parameter, and the at least one parameter indicates the type information of the resources in the target resource set.

In some embodiments, in a case where the target resource set only contains one type of resources and the first information is carried in a first MAC CE, the first MAC CE contains a first part and a second part. The first part indicates the type information of the resources in the target resource set, and the second part is used to carry the target resource set.

In some embodiments, in a case where the target resource set contains two types of resources and the first information is carried in a second MAC CE, the second MAC CE contains a first part and a second part. The first part is used to carry resources suitable for use by the second terminal device, and the second part is used to carry resources unsuitable for use by the second terminal device.

In some embodiments, a first sub-part of the first part indicates the number of resources suitable for use by the second terminal device in the target resource set, and a second sub-part of the first part is used to carry the resources suitable for use by the second terminal device; and/or, a first sub-part of the second part indicates the number of resources unsuitable for use by the second terminal device in the target resource set, and a second sub-part of the second part is used to carry the resources unsuitable for use by the second terminal device.

In some embodiments, the type information of the resources in the target resource set is determined based on second indication information transmitted by the second terminal device. The second indication information instructs the first terminal device to provide resources suitable for use by the second terminal device. Alternatively, the second indication information instructs the first terminal device to provide resources unsuitable for use by the second terminal device.

In some embodiments, in a case where the second terminal device is allowed to directly perform transmission resource selection from the resource set to be provided by the first terminal device, the second indication information instructs the first terminal device to provide the resources suitable for use by the second terminal device; and/or in a case where the second terminal device is not allowed to directly perform transmission resource selection from the resource set to be provided by the first terminal device, the second indication information instructs the first terminal device to provide the resources unsuitable for use by the second terminal device.

In some embodiments, the second indication information is carried in coordination information request signaling. Alternatively, the second indication information is carried in PC5-RRC signaling. Alternatively, the second indication information is carried in SCI.

In some embodiments, in a case where the first terminal device is a target receiver of the second terminal device, the target resource set contains the type of resources suitable for use by the second terminal device, or the target resource set contains the type of resources unsuitable for use by the second terminal device, or the target resource set contains the type of resources suitable for use by the second terminal device and the type of resources unsuitable for use by the second terminal device; and/or in a case where the first terminal device is not a target receiver of the second terminal device, the target resource set contains the type of resources unsuitable for use by the second terminal device.

In some embodiments, the target resource set is transmitted by the first terminal device in a case where an event-based triggering condition is satisfied.

In some embodiments, the type information of the resources in the target resource set is determined based on resource-pool configuration information of a first resource pool. The resource-pool configuration information indicates type information of resources to be provided by the first terminal device to the second terminal device. The first resource pool is a resource pool from which the first terminal device selects resources to be transmitted to the second terminal device.

In some embodiments, in a case where the resource-pool configuration information indicates that the first terminal device is only allowed to provide resources unsuitable for use by the second terminal device, the target resource set contains the type of resources unsuitable for use by the second terminal device. Alternatively, in a case where the resource-pool configuration information indicates that the first terminal device is only allowed to provide resources unsuitable for use by the second terminal device, and in a case where the second terminal device is allowed to directly perform transmission resource selection from the resource set to be provided by the first terminal device, the target resource set contains the type of resources suitable for use by the second terminal device and/or the type of resources unsuitable for use by the second terminal device. Alternatively, in a case where the resource-pool configuration information indicates that the first terminal device is only allowed to provide resources unsuitable for use by the second terminal device, and in a case where the second terminal device is not allowed to directly perform transmission resource selection from the resource set to be provided by the first terminal device, the target resource set contains the type of resources unsuitable for use by the second terminal device.

In some embodiments, in a case where the resource-pool configuration information indicates that the first terminal device is only allowed to provide resources suitable for use by the second terminal device, the target resource set contains the type of resources suitable for use by the second terminal device. Alternatively, in a case where the resource-pool configuration information indicates that the first terminal device is only allowed to provide resources suitable for use by the second terminal device, and in a case where the first terminal device is not a target receiver of the second terminal device, the target resource set contains the type of resources suitable for use by the second terminal device and/or the type of resources unsuitable for use by the second terminal device. Alternatively, in a case where the resource-pool configuration information indicates that the first terminal device is only allowed to provide resources suitable for use by the second terminal device, and in a case where the first terminal device is a target receiver of the second terminal device, the target resource set contains the type of resources suitable for use by the second terminal device.

In some embodiments, the resource-pool configuration information is semi-static configuration information.

In some embodiments, the communication unit above may be a communication interface or a transceiver, or may be an input/output interface of a communication chip or an SoC.

It may be understood that, the terminal device 500 according to embodiments of the disclosure may correspond to the second terminal device in the method embodiments of the disclosure, and the foregoing and other operations and/or functions of various units in the terminal device 500 are respectively intended for implementing corresponding procedures of the second terminal device in the method 300 illustrated in FIG. 16, which will not be repeated herein for the sake of simplicity.

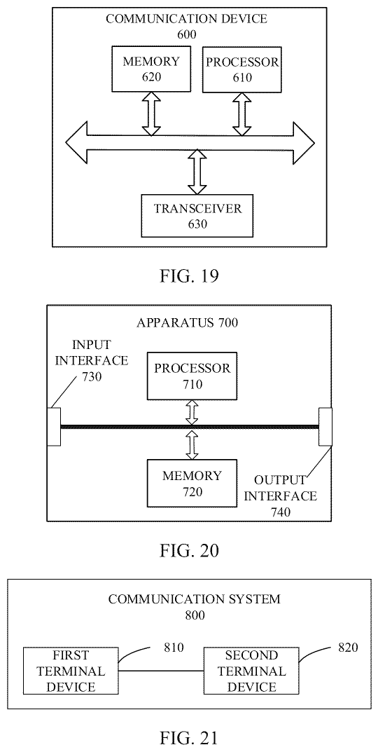

FIG. 19 is a schematic structural diagram of a communication device 600 provided in embodiments of the disclosure. The communication device 600 illustrated in FIG. 19 includes a processor 610. The processor 610 can invoke and execute a computer program stored in a memory, so as to implement the method in embodiments of the disclosure.

In some embodiments, as illustrated in FIG. 19, the communication device 600 may further include a memory 620. The processor 610 can invoke and execute a computer program stored in the memory 620, so as to implement the method in embodiments of the disclosure.

The memory 620 may be a separate device independent of the processor 610, or may be integrated into the processor 610.

In some embodiments, as illustrated in FIG. 19, the communication device 600 may further include a transceiver 630. The processor 610 can control the transceiver 630 to communicate with other devices, specifically, to transmit information or data to other devices or to receive information or data from other devices.

The transceiver 630 may include a transmitter and a receiver. The transceiver 630 may further include an antenna, where one or more antennas may be provided.

In some embodiments, the communication device 600 may specifically be the first terminal device in embodiments of the disclosure, and the communication device 600 may implement corresponding operations implemented by the first terminal device in various methods in embodiments of the disclosure, which will not be repeated herein for the sake of simplicity.

In some embodiments, the communication device 600 may specifically be the second terminal device in embodiments of the disclosure, and the communication device 600 may implement corresponding operations implemented by the second terminal device in various methods in embodiments of the disclosure, which will not be repeated herein for the sake of simplicity.

FIG. 20 is a schematic structural diagram of an apparatus provided in embodiments of the disclosure. The apparatus 700 illustrated in FIG. 20 includes a processor 710. The processor 710 can invoke and execute a computer program stored in a memory, so as to implement the method in embodiments of the disclosure.

In some embodiments, as illustrated in FIG. 20, the apparatus 700 may further include a memory 720. The processor 710 can invoke and execute a computer program stored in the memory 720, so as to implement the method in embodiments of the disclosure.

The memory 720 may be a separate device independent of the processor 710, or may be integrated into the processor 710.

In some embodiments, the apparatus 700 may further include an input interface 730. The processor 710 can control the input interface 730 to communicate with other devices or chips, and specifically, to obtain information or data transmitted by other devices or chips.

In some embodiments, the apparatus 700 may further include an output interface 740. The processor 710 can control the output interface 740 to communicate with other devices or chips, and specifically, to output information or data to other devices or chips.

In some embodiments, the apparatus may be applied to the first terminal device in embodiments of the disclosure, and the apparatus may implement corresponding operations implemented by the first terminal device in various methods in embodiments of the disclosure, which will not be repeated herein for the sake of simplicity.

In some embodiments, the apparatus may be applied to the second terminal device in embodiments of the disclosure, and the apparatus may implement corresponding operations implemented by the second terminal device in various methods in embodiments of the disclosure, which will not be repeated herein for the sake of simplicity.

In some embodiments, the apparatus in embodiments of the disclosure may also be a chip, for example, an SoC.

FIG. 21 is a schematic block diagram of a communication system 800 provided in embodiments of the disclosure. As illustrated in FIG. 21, the communication system 800 includes a first terminal device 810 and a second terminal device 820.

The first terminal device 810 may be configured to implement corresponding functions implemented by the first terminal device in the foregoing methods, and the second terminal device 820 may be configured to implement corresponding functions implemented by the second terminal device in the foregoing methods, which will not be repeated herein for the sake of simplicity.

It may be understood that, the processor in embodiments of the disclosure may be an integrated circuit chip with signal processing capabilities. During implementation, each step of the foregoing method embodiments may be completed by an integrated logic circuit of hardware in the processor or an instruction in the form of software. The processor may be a general-purpose processor, a digital signal processor (DSP), an application specific integrated circuit (ASIC), a field programmable gate array (FPGA), or other programmable logic devices, discrete gates or transistor logic devices, discrete hardware components. The methods, steps, and logic blocks disclosed in embodiments of the disclosure can be implemented or executed. The general-purpose processor may be a microprocessor, or the processor may be any conventional processor or the like. The steps of the method disclosed in embodiments of the disclosure may be directly implemented by a hardware decoding processor, or may be performed by hardware and software modules in the decoding processor. The software module can be located in a storage medium mature in the skill such as a random access memory (RAM), a flash memory, a read-only memory (ROM), a programmable ROM (PROM), or an electrically erasable programmable memory, registers, and the like. The storage medium is located in the memory. The processor reads the information in the memory, and completes the steps of the method described above with the hardware of the processor.

It may be understood that, the memory in embodiments of the disclosure may be a volatile memory or a non-volatile memory, or may include both the volatile memory and the non-volatile memory. The non-volatile memory may be an ROM, a PROM, an erasable PROM (EPROM), an electrically EPROM (EEPROM), or a flash memory. The volatile memory may be an RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It may be noted that, the memory of the systems and methods described in the disclosure is intended to include, but is not limited to, these and any other suitable types of memory.

It may be understood that, the memory above is intended for illustration rather than limitation. For example, the memory in embodiments of the disclosure may also be an SRAM, a DRAM, an SDRAM, a DDR SDRAM, an ESDRAM, an SLDRAM, a DR RAM, or the like. In other words, the memory in embodiments of the disclosure is intended to include, but is not limited to, these and any other suitable types of memory.

A computer-readable storage medium is further provided in embodiments of the disclosure. The computer-readable storage medium is configured to store a computer program.

In some embodiments, the computer-readable storage medium may be applied to the first terminal device in embodiments of the disclosure, and the computer program is operable with a computer to execute corresponding operations implemented by the first terminal device in various methods in embodiments of the disclosure, which will not be repeated herein for the sake of simplicity.

In some embodiments, the computer-readable storage medium may be applied to the second terminal device in embodiments of the disclosure, and the computer program is operable with a computer to execute corresponding operations implemented by the second terminal device in various methods in embodiments of the disclosure, which will not be repeated herein for the sake of simplicity.

A computer program product is further provided in embodiments of the disclosure. The computer program product includes computer program instructions.

In some embodiments, the computer program product may be applied to the first terminal device in embodiments of the disclosure, and the computer program instructions are operable with a computer to execute corresponding operations implemented by the first terminal device in various methods in embodiments of the disclosure, which will not be repeated herein for the sake of simplicity.

In some embodiments, the computer program product may be applied to the second terminal device in embodiments of the disclosure, and the computer program instructions are operable with a computer to execute corresponding operations implemented by the second terminal device in various methods in embodiments of the disclosure, which will not be repeated herein for the sake of simplicity.

A computer program is further provided in embodiments of the disclosure.

In some embodiments, the computer program may be applied to the first terminal device in embodiments of the disclosure. The computer program, when executed by a computer, is operable with the computer to implement corresponding operations implemented by the first terminal device in various methods in embodiments of the disclosure, which will not be repeated herein for the sake of simplicity.

In some embodiments, the computer program may be applied to the second terminal device in embodiments of the disclosure. The computer program, when executed by a computer, is operable with the computer to implement corresponding operations implemented by the second terminal device in various methods in embodiments of the disclosure, which will not be repeated herein for the sake of simplicity.

It will be appreciated by those of ordinary skill in the art that units and algorithmic operations of various examples described in connection with embodiments of the disclosure can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the disclosure.

It will be evident to those skilled in the art that, for the sake of convenience and simplicity, in terms of the specific working processes of the foregoing systems, apparatuses, and units, reference can be made to the corresponding processes in the foregoing method embodiments, which will not be repeated herein.

It will be appreciated that the systems, apparatuses, and methods disclosed in embodiments of the disclosure may also be implemented in various other manners. For example, the above apparatus embodiments are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components displayed as units may or may not be physical units, and may reside at one location or may be distributed to multiple networked units. Some or all of the units may be selectively adopted according to practical needs to achieve desired objectives of the disclosure.

In addition, various functional units described in various embodiments of the disclosure may be integrated into one processing unit or may be present as a number of physically separated units, and two or more units may be integrated into one.

If the functions are implemented as software functional units and sold or used as standalone products, they may be stored in a computer-readable storage medium. Based on such an understanding, the essential technical solution, or the portion that contributes to the prior art, or part of the technical solution of the disclosure may be embodied as software products. The computer software products can be stored in a storage medium and may include multiple instructions that, when executed, can cause a computer device, e.g., a personal computer, a server, a network device, etc., to execute some or all operations of the methods described in various embodiments of the disclosure. The above storage medium may include various kinds of media that can store program codes, such as a universal serial bus (USB) flash disk, a mobile hard drive, an ROM, an RAM, a magnetic disk, or an optical disk.

The foregoing elaborations are merely embodiments of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

What is claimed is:

1. A method for wireless communication, comprising:
determining, by a first terminal device, type information of resources in a target resource set to be provided to a second terminal device, wherein
the target resource set is used by the second terminal device to perform resource selection, and the target resource set contains at least one of: a type of resources suitable for use by the second terminal device or a type of resources unsuitable for use by the second terminal device.

2. The method of claim 1, wherein determining, by the first terminal device, the type information of the resources in the target resource set to be provided to the second terminal device comprises:
determining, by the first terminal device according to resources acquired by the first terminal device, the type information of the resources in the target resource set to be provided to the second terminal device.

3. The method of claim 2, wherein
the target resource set is carried in first information, wherein
the first information contains at least one information bit, and the at least one information bit indicates the type information of the resources in the target resource set; or
the first information contains at least one parameter, and the at least one parameter indicates the type information of the resources in the target resource set.

4. The method of claim 3, wherein
in a case where the target resource set only contains one type of resources and the first information is carried in a first media access control control element (MAC CE), the first MAC CE contains a first part and a second part, wherein the first part indicates the type information of the resources in the target resource set, and the second part is used to carry the target resource set.

5. The method of claim 1, wherein determining, by the first terminal device, the type information of the resources in the target resource set to be provided to the second terminal device comprises:
determining, by the first terminal device according to second indication information transmitted by the second terminal device, the type information of the resources in the target resource set to be provided to the second terminal device, wherein
the second indication information instructs the first terminal device to provide resources suitable for use by the second terminal device, or the second indication information instructs the first terminal device to provide resources unsuitable for use by the second terminal device.

6. The method of claim 5, wherein
in a case where the second terminal device is allowed to directly perform transmission resource selection from the resource set to be provided by the first terminal device, the second indication information instructs the first terminal device to provide the resources suitable for use by the second terminal device; and/or
in a case where the second terminal device is not allowed to directly perform transmission resource selection from the resource set to be provided by the first terminal device, the second indication information instructs the first terminal device to provide the resources unsuitable for use by the second terminal device.

7. The method of claim 5, wherein
the second indication information is carried in coordination information request signaling, or the second indication information is carried in sidelink control information (SCI).

8. The method of claim 1, wherein the target resource set is suitable for use by the second terminal device, and the resources in the target resource set are preferentially selected by the second terminal device in a case where the second terminal device selects resources for transmitting sidelink (SL) data.

9. The method of claim 1, wherein the target resource set is unsuitable for use by the second terminal device, and the resources in the target resource set are not selected by the second terminal device during resource selection of the second terminal device.

10. A terminal device, comprising:
a transceiver;
a processor coupled to the transceiver; and
a memory storing a computer program which, when executed by the processor, causes the terminal device to:
determine type information of resources in a target resource set to be provided to another terminal device, wherein
the target resource set is used by the other terminal device to perform resource selection, and the target resource set contains at least one of: a type of resources suitable for use by the other terminal device or a type of resources unsuitable for use by the other terminal device.

11. The terminal device of claim 10, wherein the computer program executed by the processor to cause the terminal device to determine the type information of the resources in the target resource set to be provided to the other terminal device is executed by the processor to cause the terminal device to:
determine, according to resources acquired by the terminal device, the type information of the resources in the target resource set to be provided to the other terminal device.

12. The terminal device of claim 11, wherein
the target resource set is carried in first information, wherein
the first information contains at least one information bit, and the at least one information bit indicates the type information of the resources in the target resource set; or
the first information contains at least one parameter, and the at least one parameter indicates the type information of the resources in the target resource set.

13. The terminal device of claim 10, wherein the computer program executed by the processor to cause the terminal device to determine the type information of the resources in the target resource set to be provided to the other terminal device is executed by the processor to cause the terminal device to:
determine, according to second indication information transmitted by the other terminal device, the type information of the resources in the target resource set to be provided to the other terminal device, wherein
the second indication information instructs the terminal device to provide resources suitable for use by the other terminal device, or the second indication information instructs the terminal device to provide resources unsuitable for use by the other terminal device.

14. The terminal device of claim 10, wherein the target resource set is suitable for use by the other terminal device, and the resources in the target resource set are preferentially selected by the other terminal device in a case where the other terminal device selects resources for transmitting sidelink (SL) data.

15. The terminal device of claim 10, wherein the target resource set is unsuitable for use by the other terminal device, and the resources in the target resource set are not selected by the other terminal device during resource selection of the other terminal device.

16. A terminal device, comprising:
a transceiver;
a processor coupled to the transceiver; and
a memory storing a computer program which, when executed by the processor, causes the terminal device to:
receive first information from another terminal device, wherein
the first information contains a target resource set, the target resource set is used by the terminal device to perform resource selection, and the target resource set contains at least one of:
a type of resources suitable for use by the terminal device or a type of resources unsuitable for use by the terminal device.

17. The terminal device of claim 16, wherein
type information of resources in the target resource set is determined based on resources acquired by the other terminal device.

18. The terminal device of claim 17, wherein
the first information contains at least one information bit, and the at least one information bit indicates the type information of the resources in the target resource set; or
the first information contains at least one parameter, and the at least one parameter indicates the type information of the resources in the target resource set.

19. The terminal device of claim 16, wherein the target resource set is suitable for use by the terminal device, and the computer program is further executed by the processor to cause the terminal device to:
select the resources in the target resource set preferentially in a case where the terminal device selects resources for transmitting sidelink (SL) data.

20. The terminal device of claim 16, wherein the target resource set is unsuitable for use by the other terminal device, and the computer program is further executed by the processor to cause the terminal device to:
avoid selecting the resources in the target resource set during resource selection.
